(19) United States
(12) Patent Application Publication
(10) Pub. No.: US 2014/0120894 A1
(43) Pub. Date: May 1, 2014

(54) Mobile Device and Method for Controlling Application Procedures of the Mobile Device Thereof

(71) Applicant: Cywee Group Limited, Road Town (VG)

(72) Inventors: Chin-Lung Lee, Zhongli City (TW); Shun-Nan Liou, Kaohsiung City (TW); Zhou Ye, Foster City, CA (US)

(73) Assignee: Cywee Group Limited, Road Town (VG)

(21) Appl. No.: 14/059,614

(22) Filed: Oct. 22, 2013

(30) Foreign Application Priority Data
Oct. 25, 2012 (CN) 201210411030.2

(51) Int. Cl. H04W 8/22

(52) U.S. Cl. CPC H04W 8/22
USPC 455/418

(57) ABSTRACT

A mobile device and a method for controlling application procedures of a mobile device are provided. The mobile device includes a motion sensor configured to detect motion of the mobile device and generate a motion signal, and a micro-processor configured to receive the motion signal, determine whether the mobile device has been continuously knocked for a predetermined number of times, and control an application procedure accordingly. The method for controlling the application procedures for the mobile device is also disclosed. Therefore, a user can control the mobile device conveniently, even in an occasion not convenient for the user to control the mobile device by its touch panel or physical buttons.

### FIELD OF THE INVENTION

The present invention relates to a method for controlling application procedures, and more particularly, to a method for controlling an application procedure of a mobile device by sensing external motion(s).

### BACKGROUND OF THE INVENTION

In recent years, as smart phones become popular, many application procedures (including “APP”, which are application software developed for low-power handheld devices) have been developed. Using various application procedures has become one part of human life.

In the prior art, a user must use a touch panel or button(s) of the smart phone to operate the application procedures. However, in some occasions, it's not convenient for the user to operate the application procedures through the touch panel or the button(s). For example, most of the smart phones dispose the camera lens and the touch panel on opposite sides of the housing of the smart phone. For this reason, it's not convenient for the user when the user uses the smart phone to take a photographic self-portrait. Or when the user cannot answer an incoming call during a meeting, the user will need to locate and press the reject button so as to stop the smart phone from ringing. Since a period of time is required for the user to complete this action, the user may feel embarrassed on the occasion.

Hence, how to provide a solution for the user to operate the application procedures without using the touch panel or the button has become an issue is this field.

### SUMMARY OF THE INVENTION

According to one of the objectives of the present invention, a mobile device and a method for controlling application procedures of the mobile device are provided in order to improve convenience of using the mobile device.

According to one aspect of the present invention, a method for controlling application procedures of the mobile device is provided. The abovementioned method for controlling application procedures of the mobile device includes the following steps: (a) detecting whether the mobile device is knocked or not; and (b) when detecting that the mobile device has been continuously knocked for a predetermined number of times, controlling an application procedure stored in the mobile device accordingly.

In one embodiment of the method of the present invention, if the mobile device is detected to be continuously knocked for two times on its front side or on its back side when the mobile device is in a shooting mode, the application procedure is to enable a camera module to perform a focus function and take a photograph.

In another embodiment of the method of the present invention, if the mobile device is detected to be continuously knocked for two times when the mobile device is in a silent mode and an incoming call is received by the mobile device, the application procedure is to reject the incoming call.

In another embodiment of the method of the present invention, if the mobile device is detected to be continuously knocked for two times when the mobile device is in a normal mode (i.e., with the ringer turned on) and an incoming call is received by the mobile device, the application procedure is to reject the incoming call.

In another embodiment of the method of the present invention, if the mobile device is detected to be continuously knocked for two times when a ringer of the mobile device is turned on, the application procedure is to turn off the ringer of the mobile device; and if the mobile device is detected to be continuously knocked for two times when the ringer of the mobile device is turned off, the application procedure is to turn on the ringer of the mobile device.

In another embodiment of the method of the present invention, if the mobile device is detected to be continuously knocked for two times on its front side or on its back side when the mobile device is in a multimedia playback mode, the application procedure is to switch the mobile device from the playback mode to a pause mode to pause the multimedia (e.g., video or audio) reproduction; and if the mobile device is detected to be continuously knocked for two times on its front side or on its back side when the mobile device is in the pause mode, the application procedure is to switch the mobile device from the pause mode to the playback mode.

In another embodiment of the method of the present invention, if the mobile device is detected to be continuously knocked for two times on its left side or on its right side when the mobile device is in an audio playback mode, the application procedure is to stop the current audio reproduction and jump to play a previous song or a next song.

In another embodiment of the method of the present invention, the method further includes the following steps: using a motion sensor to detect the motion of the mobile device in a 3-D (three dimension) coordinate system, using the motion signal to detect in which direction the mobile device is being knocked, and enabling the application procedure accordingly.

According to the abovementioned objective and another one of the objectives of the present invention, a mobile device for executing the abovementioned methods is provided.

In another embodiment of the mobile device of the present invention, the mobile device can be a smart phone, a camera, or a multimedia player.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram showing a mobile device according to a first embodiment.

FIG. 2 is a flowchart illustrating a method for enabling an application procedure of a mobile device according to the first embodiment.

FIG. 3 is a block diagram showing a mobile device according to a second embodiment.

FIG. 4 is a flowchart illustrating a method for enabling an application procedure of a mobile device according to the second embodiment.

FIG. 5 is a mapping table of predetermined numbers and corresponding application procedures.

FIG. 6 is a flowchart illustrating a method for enabling an application procedure of a mobile device according to a third embodiment.

### DETAILED DESCRIPTION OF PREFERRED EMBODIMENTS

Certain terms are used throughout the description and following claims to refer to particular components. As one skilled in the art will appreciate, manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”.

Please be noted that the mobile device of the present invention can be a mobile phone, a camera, or a multimedia player (e.g., a music player) in order to help understand the present invention. In the following embodiments, the mobile device takes a smart phone as an example, however, this should not be a limitation of the present invention.

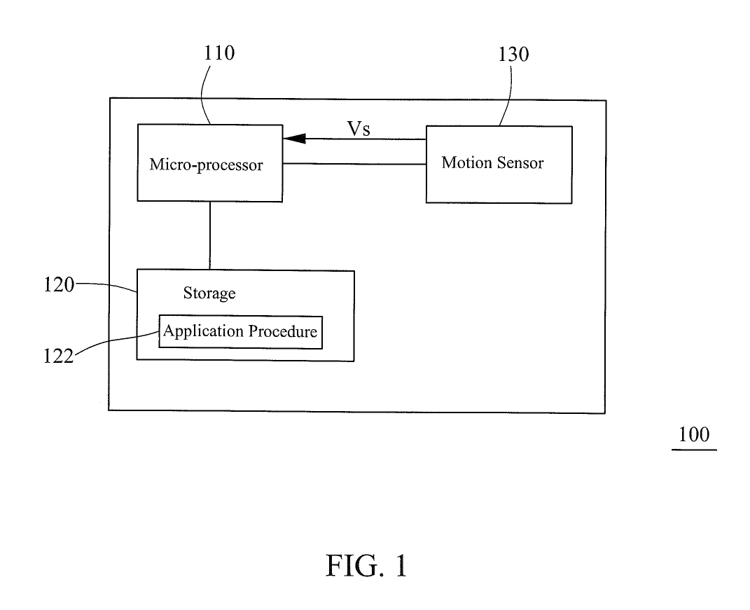

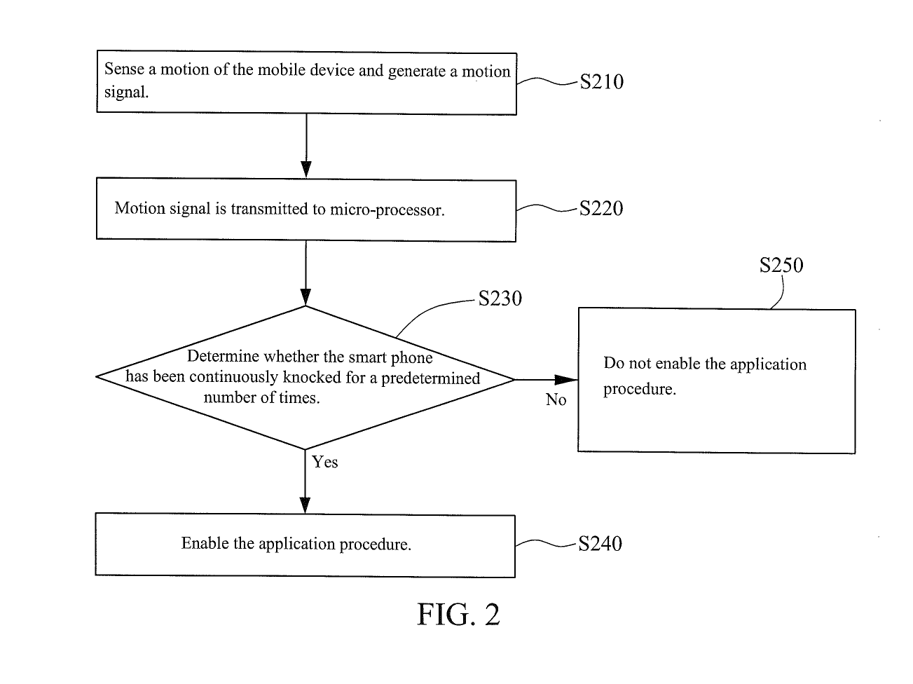

Please refer to FIG. 1 together with FIG. 2. FIG. 1 is a block diagram showing a mobile device according to a first embodiment, and FIG. 2 is a flowchart illustrating a method for enabling an application procedure of a mobile device according to the first embodiment. In FIG. 1, the mobile device is a smart phone including a micro-processor 110, a storage 120, and a motion sensor 130, wherein there is an application procedure 122 stored in the storage 120. In this embodiment, the motion sensor 130 may include an accelerometer, or a gyroscope, or a combination of an accelerometer and a gyroscope, to detect motion of the mobile device in a 3-D (three dimension) coordinate system, however, this should not be a limitation of the present invention. Other sensing modules, for example, a component using piezoelectric effect to detect motion of the mobile device, can also be used as the motion sensor 130 in this embodiment. As shown in Step S210 of FIG. 2, when the smart phone 100 is knocked, the motion sensor 130 will sense a motion and generate a motion signal Vs. After that, as shown in Step S220 of FIG. 2, the motion signal Vs will be transmitted to the micro-processor 110. As shown in Step S230 of FIG. 2, the micro-processor 110 will determine whether the smart phone 100 has been continuously knocked for a predetermined number of times (i.e., knocked for a predetermined number of times within a short period of time). In this embodiment, the predetermined number of times is set to two, but this should not be a limitation of the embodiment. As shown in Step S240 of FIG. 2, when the number of times that the smart phone 100 being continuously knocked reaches the predetermined number, the micro-processor 110 will enable the application procedure 122 stored in the storage 120. As shown in Step 250 of FIG. 2, when the number of times that the smart phone 100 has been knocked does not reach the predetermined number, the application procedure 122 won't be enabled. Please be noted that, in this embodiment, “the smart phone 100 is knocked” means that the smart phone 100 senses a motion. The motion may be caused by the housing (not shown) of the smart phone 100 being directly knocked by the user. The motion may also be caused by, for example, when the smart phone 100 is placed on a table (not shown), the user knocks on the table and the smart phone 100 senses a motion.

In this embodiment, the abovementioned application procedure can be used for switching the smart phone from a first mode to a second mode, and vice versa. For example, the modes may be answering/rejecting an incoming call, turning on/off a ringer of the smart phone, switching the smart phone from a normal mode to a speaker mode (also called speakerphone mode), or switching the smart phone from a speaker mode to a normal mode. The details will be explained in the following paragraphs.

In one embodiment of the present invention, the abovementioned application procedure is to answer an incoming call. Therefore, even if the smart phone is put in a user's pocket, the smart phone 100 will enable the application procedure 122 to answer the incoming call when the user continuously knocks the pocket for two times (double tap) in order to make the smart phone 100 sense motion(s) from the double tap. Comparing to the prior art, the user won't need to take out the smart phone 100 from his/her pocket and press the answer button to answer the incoming call.

In another embodiment of the present invention, the abovementioned application procedure is to reject an incoming call. If a ringer of the smart phone is ringing during a conference, the user can continuously knock the smart phone 100 for two times (double tap) to reject the incoming call. Therefore, the user is capable of quickly rejecting the incoming call and won't need to hold the smart phone 100 and press the reject button as in the prior art. Moreover, the smart phone can enable the same application procedure regardless whether the smart phone is in a silent mode or in a normal mode; that is to say, if the smart phone is detected to be continuously knocked for two times (double tap) when the smart phone is in a silent mode and an incoming call is received by the smart phone, the same application procedure may also be enabled to reject the incoming call.

In another embodiment of the present invention, the abovementioned application procedure is to execute the following steps: when a ringer of the smart phone 100 is turned on, the application procedure is to turn off the ringer of the smart phone 100; and when the ringer of the smart phone 100 is turned off, the application procedure is to turn on the ringer of the smart phone 100. Therefore, when the user is about to walk into a venue (e.g. a cinema) and desires to turn off the ringer of the smart phone 100, the user can merely knock the smart phone 100 so as to quickly turn off the ringer of the smart phone 100; and when the user leaves such venue, the user can merely knock the smart phone 100 again so as to turn on the ringer of the smart phone 100.

In another embodiment of the present invention, the abovementioned application procedure is to execute the following steps: when the smart phone 100 is in a normal mode (i.e., the user needs to hold the smart phone close to his/her face to be able to hear and talk for the phone call), the application procedure is enabled to switch the smart phone 100 from the normal mode to a speaker mode; and when the smart phone 100 is in the speaker mode, the application procedure is enabled to switch the smart phone 100 from the speaker mode to the normal mode. Hence, when the user is not convenient to answer an incoming call with the normal mode (such as, when driving a car), the user can knock the smart phone 100 so as to switch the smart phone 100 from the normal mode to the speaker mode; afterwards, the user can knock the smart phone 100 again so as to switch the smart phone 100 from the speaker mode back to the normal mode.

In another embodiment of the present invention, the abovementioned application procedure is to execute the following steps: if the smart phone 100 is detected to be continuously knocked for two times (double tap) on its front side or on its back side when the smart phone 100 is in a playback mode, the application procedure is to switch the smart phone 100 from the playback mode to a pause mode; and if the smart phone 100 is detected to be continuously knocked for two times (double tap) on its front side or on its back side when the smart phone 100 is in the pause mode, the application procedure is to switch the smart phone 100 from the pause mode to the playback mode. Hence, when the smart phone 100 is reproducing a multimedia bistream, the user can continuously knock the smart phone 100 on its front side or on its back side for two times (double tap) so as to pause the multimedia bitstream reproduction; afterwards, the user can continuously knock the smart phone 100 on its front side or on its back side for two times (double tap) so as to resume the multimedia bitstream reproduction. Alternatively, the smart phone 100 may also be configured so that the user can control the smart phone 100 to play a previous song or a next song by continuously knock the smart phone 100 on its left side or on its right side for two times (double tap).

In this embodiment, the motion sensor 130 may include an accelerometer, or a gyroscope, or a combination of an accelerometer and a gyroscope. The motion sensor 130 can detect motion of the smart phone 100 in different directions in a 3-D coordinate system, and generates a motion signal. Therefore, the micro-processor 110 of the smart phone 100 can receive the motion signal corresponding to the smart phone motion and determine in which direction the smart phone 100 is being continuously knocked, and enable the corresponding application procedure accordingly. For example, when the smart phone 100 is continuously knocked on its right side, the application procedure is to play a next song; and when the smart phone 100 is continuously knocked on its left side, the application procedure is to play a previous song.

In another embodiment, the abovementioned application procedure is to enable a camera module for taking a photograph. Hence, even if the camera lens of the camera module and the touch panel are disposed on opposite sides of the smart phone 100, the user can continuously knock the smart phone 100 so as to enable the camera module (not shown) to perform a focus function and take a photograph. Therefore, it's convenient for the user to take a photographic self-portrait by himself.

Please note that, detecting whether the smart phone is continuously knocked for two times (double tap) is merely one embodiment of the present invention, and should not be a limitation of the present invention. In other embodiments, the mobile phone can enable different application procedures by detecting and determining the number of times that the smart phone is being knocked. Some embodiments will be explained in the following paragraphs.

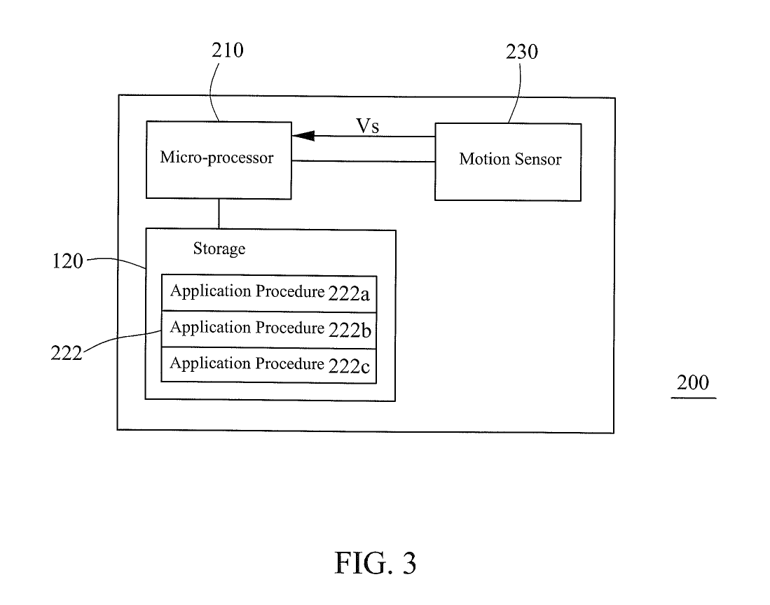

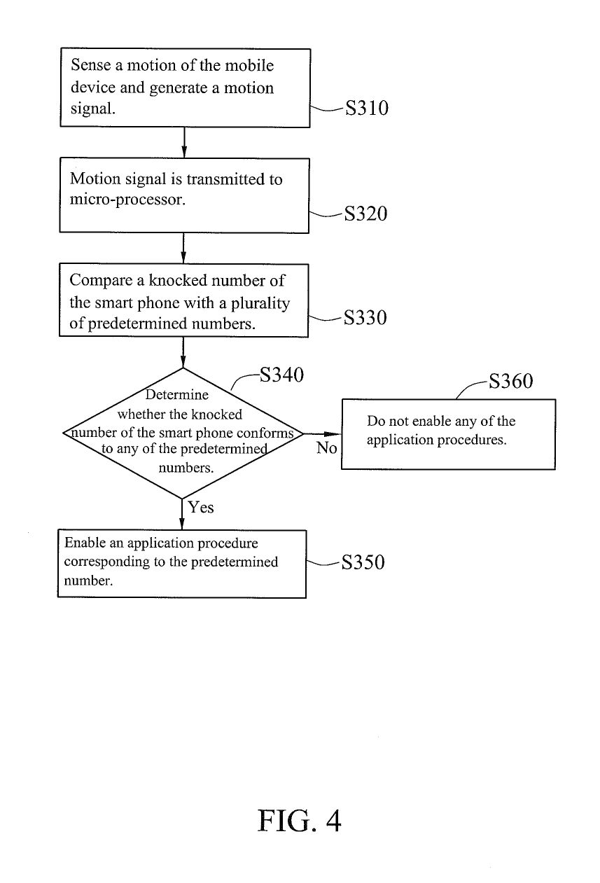

Please refer to FIG. 3 together with FIG. 4. FIG. 3 is a block diagram showing a mobile device according to a second embodiment, and FIG. 4 is a flowchart illustrating a method for enabling an application procedure of a mobile device according to the second embodiment. In FIG. 3, the mobile device is a smart phone 200 including a micro-processor 210, a storage 220, and a motion sensor 230, wherein there are a plurality of application procedures 222 stored in the storage 220. In this embodiment, there are three application procedures 222 stored in the storage 220, including the application procedure 222a, the application procedure 222b, and the application procedure 222c.

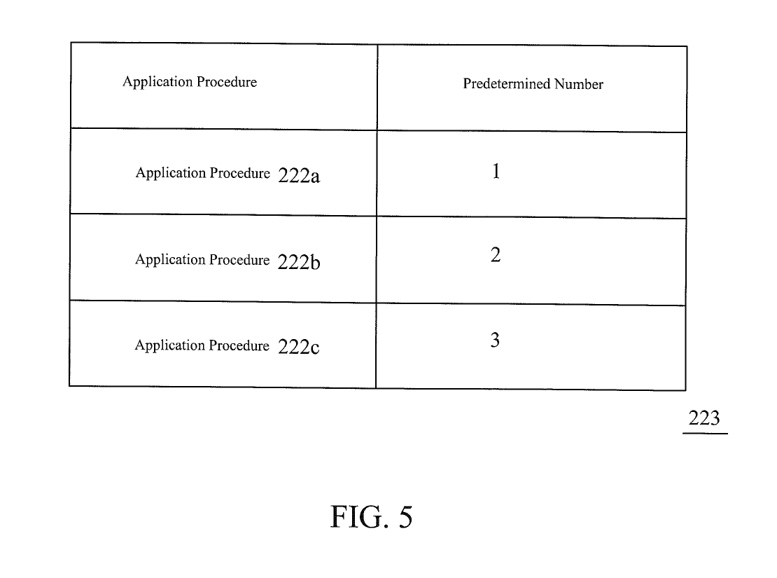

Please also refer to FIG. 5. FIG. 5 is a mapping table 223 of application procedures and predetermined numbers. As can be seen from the mapping table 223, different application procedures are corresponding to different predetermined numbers, and the mapping table 223 is stored in the storage 220 of the smart phone 200. It should be noted that the predetermined numbers listed in the abovementioned mapping table 223 are merely examples. Those skilled in that art should understand that: the predetermined numbers can be adjusted by manufactures or users of the smart phone 200 based on practical situations.

In this embodiment, as shown in Step S310, when the motion sensor 230 detects that the smart phone 200 is knocked, a motion signal will be generated accordingly. After that, as shown in Step S320, the motion signal Vs will be transmitted to the micro-processor 210 for determining the number of times that the smart phone 200 has been knocked (for brevity, referred to as “the knocked number” in the following paragraphs). As shown in Step S330, when the motion signal Vs is received by the micro-processor 210, the micro-processor 210 will determine the knocked number, compare the knocked number with the predetermined numbers recorded in the mapping table 223. The micro-processor 210 then determines whether the knocked number conforms to one of the predetermined numbers, as is shown in Step S340. If the knocked number conforms to one of the plurality of predetermined numbers, go to Step S350 in order to enable the application procedure corresponding to the predetermined number. For example, if the smart phone 200 is detected to be continuously knocked for three times (triple tap), the corresponding application procedure 22c is enabled. If the knocked number does not conform to any one of the plurality of predetermined numbers, go to Step S360 and do not enable any of the application procedures stored in the storage 220.

In another embodiment of the present invention, the application procedure 22a is to answer an incoming call; and the application procedure 22b is to execute the following step: if the smart phone 200 is in a normal mode, the application procedure is to switch the smart phone 200 from the normal mode to a speaker mode. Hence, when the user is not convenient to answer an incoming call with the normal mode (for example, when driving a car), the user can knock the smart phone 200 for one time so as to answer the incoming call, and continuously knock the smart phone 200 for two times (double tap) so as to switch the smart phone 200 from the normal mode to the speaker mode.

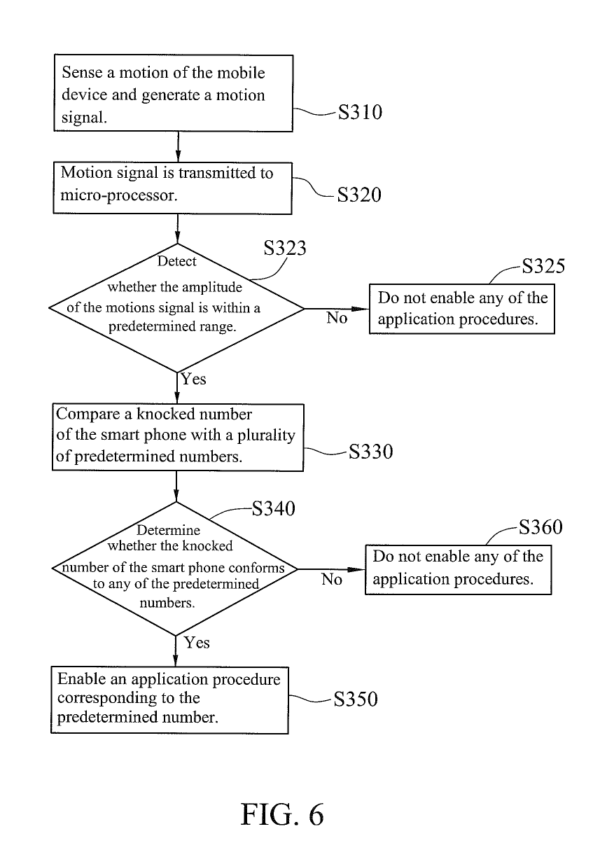

Please refer to FIG. 3 together with FIG. 6. FIG. 6 is a flowchart illustrating a method for enabling an application procedure of a mobile device according to a third embodiment. Comparing with FIG. 4, the flowchart shown in FIG. 6 further includes Step S323 and Step S325. In Step S323, detect whether the amplitude of the motion signal Vs is within a predetermined amplitude range. If the amplitude of the motion signal Vs is within a predetermined amplitude range (i.e., smaller than an upper limit of the predetermined amplitude range and larger than a lower limit of the predetermined amplitude range), go to execute the following steps (including the Steps S330, S340, S350, and S360); or if the amplitude of motion signal Vs is outside the predetermined amplitude range, go to Step S325 and do not enable any of the application procedures. Therefore, if the smart phone 200 is erroneously touched by the user, none of the application procedures of the smart phone 200 will be enabled when the amplitude of the motion signal Vs is not within the predetermined amplitude range.

In conclusion, the application procedure stored in the smart phone can be controlled by sensing whether the smart phone is knocked or not. Hence, when the user is in an occasion inconvenient to operate corresponding application procedure(s) through touch panel or button(s) of the smart phone, the user can knock the smart phone so as to control the corresponding application procedures. As a result, user's convenience of using the smart phone can be greatly improved.

Moreover, in the abovementioned embodiments, although the smart phone is taken as an example of the mobile device, those skilled in the art should understand that the method for controlling application procedure(s) of the present invention can also be applied to mobile devices of other types, such as tablet PC, multimedia player, or PDA.

Those skilled in the art will readily observe that numerous modifications and alterations of the device and method may be made while retaining the teachings of the present invention.

What is claimed is:

1. A method for controlling an application procedure of a mobile device, comprising:
detecting whether the mobile device is knocked or not; and
when detecting that a number of times that the mobile device being knocked conforms to a predetermined number, controlling the application procedure stored in the mobile device.

2. The method as claimed in claim 1, wherein if the mobile device is detected to be continuously knocked for two times on its front side or on its back side when the mobile device is in a shooting mode, the application procedure is to enable a camera module to perform a focus function and take a photograph.

3. The method as claimed in claim 1, wherein if the mobile device is detected to be continuously knocked for two times when the mobile device is in a silent mode and an incoming call is received by the mobile device, the application procedure is to reject the incoming call.

4. The method as claimed in claim 1, wherein if the mobile device is detected to be continuously knocked for two times when the mobile device is in a normal mode and an incoming call is received by the mobile device, the application procedure is to reject the incoming call.

5. The method as claimed in claim 1, wherein:
if the mobile device is detected to be continuously knocked for two times when a ringer of the mobile device is turned on, the application procedure is to turn off the ringer of the mobile device; and
if the mobile device is detected to be continuously knocked for two times when the ringer of the mobile device is turned off, the application procedure is to turn on the ringer of the mobile device.

6. The method as claimed in claim 1, wherein:
if the mobile device is detected to be continuously knocked for two times on its front side or on its back side when the mobile device is in a playback mode, the application procedure is to switch the mobile device from the playback mode to a pause mode; and
if the mobile device is detected to be continuously knocked for two times on its front side or on its back side when the mobile device is in the pause mode, the application procedure is to switch the mobile device from the pause mode to the playback mode.

7. The method as claimed in claim 1, wherein when the mobile device is in a playback mode, if the mobile device is detected to be continuously knocked for two times on a first side of the mobile device, the application procedure is to play a previous song, and if the mobile device is detected to be continuously knocked for two times on a second side of the mobile device, the application procedure is to play a next song.

8. The method as claimed in claim 1, further comprising:
using a motion sensor to detect motion of the mobile device in a 3-D coordinate system; and
using the motion signal to detect in which direction the mobile device is being knocked.

9. The method as claimed in claim 1, wherein the application procedure is controlled to switch the mobile device from a first mode to a second mode.

10. A mobile device, comprising:
a motion sensor for detecting whether the mobile device is knocked or not; and
a micro-processor for controlling an application procedure stored in a storage of the mobile device when detecting that a number of times that the mobile device being knocked conforms to a predetermined number.

11. The mobile device as claimed in claim 10, wherein if the mobile device is detected to be continuously knocked for two times on its front side or on its back side when the mobile device is in a shooting mode, the application procedure is to enable a camera module to perform a focus function and take a photograph.

12. The mobile device as claimed in claim 10, wherein if the mobile device is detected to be continuously knocked for two times when the mobile device is in a silent mode and an incoming call is received by the mobile device, the application procedure is to reject the incoming call.

13. The mobile device as claimed in claim 10, wherein if the mobile device is detected to be continuously knocked for two times when the mobile device is in a normal mode and an incoming call is received by the mobile device, the application procedure is to reject the incoming call.

14. The mobile device as claimed in claim 10, wherein:
if the mobile device is detected to be continuously knocked for two times when a ringer of the mobile device is turned on, the application procedure is to turn off the ringer of the mobile device; and
if the mobile device is detected to be continuously knocked for two times when the ringer of the mobile device is turned off, the application procedure is to turn on the ringer of the mobile device.

15. The mobile device as claimed in claim 10, wherein:
if the mobile device is detected to be continuously knocked for two times on its front side or on its back side when the mobile device is in a playback mode, the application procedure is to switch the mobile device from the playback mode to a pause mode; and
if the mobile device is detected to be continuously knocked for two times on its front side or on its back side when the mobile device is in the pause mode, the application procedure is to switch the mobile device from the pause mode to the playback mode.

16. The mobile device as claimed in claim 10, wherein if the mobile device is detected to be continuously knocked for two times on its left side or on its right side when the mobile device is in a playback mode, the application procedure is to play a previous song or a next song.

17. The mobile device as claimed in claim 10, wherein the motion sensor detects motion of the mobile device in a 3-D coordinate system and generates a motion signal, and the micro-processor receives the motion signal, determines in which direction the mobile device is being knocked, and controls the application procedure accordingly.

18. A mobile device, comprising:
a motion sensor configured to detect motion of the mobile device and generate a motion signal;
a micro-processor configured to receive the motion signal, determine whether the mobile device has been continuously knocked for a predetermined number of times, and control an application procedure accordingly.

19. The mobile device as claimed in claim 18, wherein the micro-processor receives the motion signal, determines in which direction the mobile device has been continuously knocked, and control the application procedure accordingly.

20. The mobile device as claimed in claim 18, wherein the application procedure is enabled to switch the mobile device from a first mode to a second mode.
